(19) United States
(12) Patent Application Publication
(10) Pub. No.: US 2015/0043311 A1
(43) Pub. Date: Feb. 12, 2015

(54) EXECUTION OF COMMANDS IN AN ELECTRONIC DEVICE

(71) Applicant: Your Voice S.p.a., Milano (IT)

(72) Inventor: Luca Agostini, Milano (IT)

(73) Assignee: Your Voice S.p.a., Milano (IT)

(21) Appl. No.: 13/963,564

(22) Filed: Aug. 9, 2013

(51) Int. Cl. G08C 23/02

(52) U.S. Cl. CPC G08C 23/02
USPC 367/197

(57) ABSTRACT

An electronic device (1) includes an input interface (10) configured for detecting sounds and translating the sounds into electric signals; a recognizing unit (20) configured for recognizing a blow (B) from an electric signal (ES) provided by the input interface (10); and an execution unit (30) configured for executing one or more determined commands of the electronic device (1) depending on the recognition of the blow (B).

### BACKGROUND OF THE INVENTION

1. Field of the invention

The present invention refers to the execution of commands in an electronic device.

2. State of the art

As known, mobile phones, especially the so called smart phones, are capable of performing a number of commands based on data stored in memory registers thereof and/or on data received through communication interfaces.

Said commands can be activated by means of suitable interfaces, which provide several options in order to let the user interact with the device and input the desired commands.

User interfaces which have been significantly developed in recent years include displays having “touch screen” capabilities: these allow users to select data, to zoom images, to scroll lists of items, etc., just by touching the display in determined manners. For example, in order to select data/items it is sufficient to touch the screen in the position wherein the data/item is displayed, in order to zoom images a user can double-tap on the screen or move apart his/her fingers while the same are in contact with the screen, in order to scroll a list of items a user can drag up and down a cursor associated with the list or just flick on any portion of the list, etc.

### SUMMARY OF THE INVENTION

It is an object of the present invention to provide an alternative way for a user to cause the execution of commands in an electronic device, and in particular in a smart phone.

Another object of the present invention is to provide a simple way to cause the execution of commands in an electronic device, in particular a smart phone.

Another object of the present invention is to allow a user to easily activate commands in an electronic device, in particular a smart phone, for example while holding the device in one hand, with no need to use the other hand.

These and other objects are substantially achieved by an electronic device according to the present invention.

### BRIEF DESCRIPTION OF THE DRAWINGS

Further features and advantages will become more apparent from the detailed description of preferred and non exclusive embodiments of the invention. The description is provided hereinafter with reference to the attached drawings, which are presented by way of non limiting example, wherein:

FIG. 1 is a pictorial representation of a user using the invention;

FIG. 2 shows a block diagram representative of an electronic device according to the present invention; and

FIG. 3 shows a waveform signal representative of data employed in the invention.

### DETAILED DESCRIPTION OF THE INVENTION

In the accompanying drawings reference numeral 1 indicates an electronic device according to the present invention.

The electronic device 1 is preferably a portable or mobile device. For example, the electronic device 1 can be a mobile phone, and in particular a so-called smart phone, or a tablet.

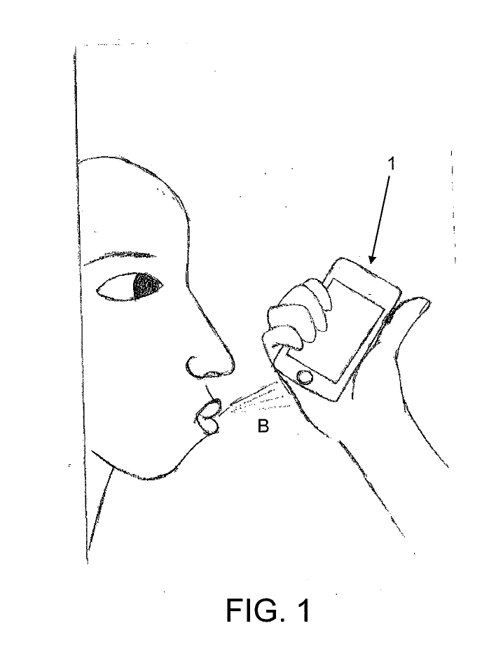

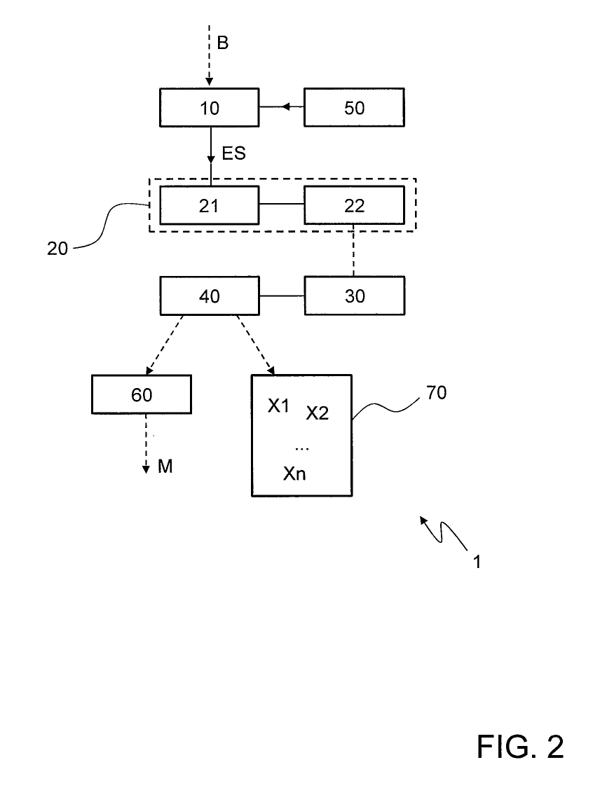

The electronic device 1 (FIGS. 1, 2) includes an input interface 10 configured for detecting sounds and translating said sounds into corresponding electric signals ES.

Preferably the input interface 10 comprises a microphone. In practice, the input interface 10 can be the electro-mechanical transducer that is used in order to translate a user's voice into electric signals during telephone calls in order to transmit the user's voice to the device held by the person who is speaking with said user.

Preferably the input interface 10 is normally off. This means that, unless the input interface 10 is activated, for example directly or indirectly by the user, it is off

For example, the microphone of a mobile phone does not usually operate unless a telephone call is set up.

Preferably, the electronic device 1 further comprises an activation element 50 active at least on the input interface 10 in order to selectively activate/deactivate the same. In particular, the activation element 50 can be operated by the user, so that the latter can activate/deactivate the input interface 10.

In a preferred embodiment, the activation element 50 includes a button which activates said input interface 10 when a user presses said button.

For example, said button can be a hardware button, i.e., a button not provided by a touch screen feature.

For example, said button can be the button usually employed to turn the electronic device 1 on when it is off. In several operating systems currently available for smart phones, when the button is pressed for a few seconds while the electronic device 1 is already on, a dialog box for communicating with the operating system is made available. By cooperating with this feature it is possible to activate the input interface 10 upon request of the user, i.e., by means of the activation element 50.

However it has to be understood that also other types of buttons and, more in general, other types of activation elements can be effectively employed in order to activate the input interface 10.

By means of the activation element 50 an activation/deactivation command can be sent to the input interface 10 so as to selectively activate/deactivate said input interface 10.

The electronic device 1 further comprises a recognizing unit 20 coupled to the input interface 10. The recognizing unit 20 is configured for recognizing a blow B from an electric signal ES provided by said input interface 10.

Preferably the recognizing unit 20 comprises a recognition memory 21, storing recognition reference data, and a comparison unit 22 coupled with said recognition memory 21 and said input interface 10. The comparison unit 22 is configured for comparing the electric signal ES provided by the input interface 10 with the recognition reference data.

Based on this comparison the recognizing unit 20 determines whether the electric signal ES provided by the input interface 10 is representative of a blow B. In other words, the recognizing unit 20 is capable of determining whether a user has blown into the input interface 10. This circumstance can be recognized, for example, if the electric signal ES substantially matches the recognition reference data.

Preferably the recognition reference data include data representative of a reference waveform, indicative of a blow waveform.

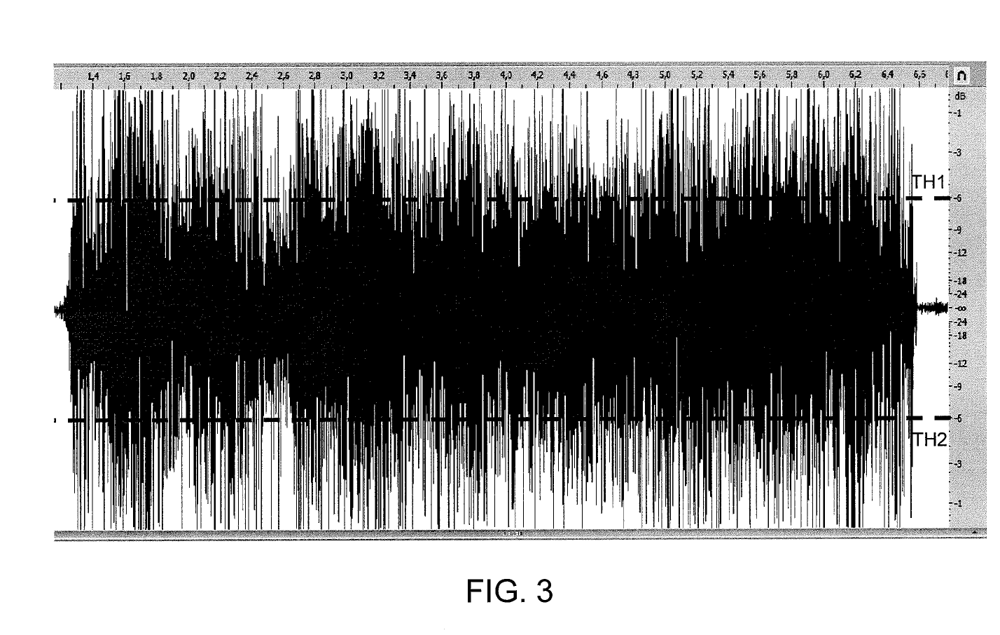

FIG. 3 schematically shows such waveform. The abscissa axis indicates time (seconds) and the ordinate axis indicates the sound amplitude (dB). The amplitude limits are those defined by the detection capability of the microphone, i.e., of the input interface 10.

In a preferred embodiment the blow B can be recognized as follows. The amplitude of the electric signal ES is compared with a couple of thresholds TH1, TH2: if the amplitude of the electric signal ES exceeds the thresholds TH1, TH2 for a determined number of times in a determined time period, then it can be assumed that the electric signal ES is generated from a blow B.

For example, it can be assumed that the electric signal ES is generated by the blow B if the amplitude of the electric signal ES exceed the thresholds TH1, TH2 about 30-50 times every second, for substantially the whole duration of the same electric signal ES.

For example, the thresholds TH1, TH2 can be set at about −6 dB.

It has to be understood that the person skilled in the art is capable of modifying the above values depending on other basic processing parameters such as, for example, sampling rate applied to the electric signal ES before it is digitally processed, possible filters applied to the electric signal ES before and/or after sampling, etc.

According to the invention, the electronic device 1 further comprises an execution unit 30 configured for executing one or more determined commands of said electronic device 1 depending on the recognition of said blow B.

In other terms, the execution unit 30 is coupled at least to said recognizing unit 20 so that, upon recognition of the blow B, one or more determined commands are executed.

Preferably the electronic device 1 further comprises a command memory 40 storing one or more commands of said electronic device 1. The execution unit 30 is coupled to said command memory 40 for selecting said one or more determined commands among the one or more commands stored in said command memory 40. In practice, the command memory 40 contains at least one or more commands to be executed upon recognition of the blow B.

Preferably the electronic device 1 comprises a communication module 60 configured at least for sending information such as, for example, an email, a message, etc.

The communication module 60 is provided with all the necessary hardware and software resources in order to remotely connect with an addressee to which the user of electronic device 1 wishes to send certain information.

Preferably the connection capabilities of communication module 60 comprise wireless connection capabilities for connection to a local area network and/or to a wide area network.

In one embodiment, said one or more determined commands include a command of sending a message M through said communication module 60.

For example, the message M can be an email message, an electronic fax message, an SMS message, a post to be posted on a determined page of a blog or a social network, a message to be sent to another user using a social network environment, etc.

Preferably the electronic device 1 comprises a display 70 on which one or more items X1 . . . Xn can be displayed. Such items can include information, graphic images, icons, etc.; in general the display 70 can provide the user with any kind of items/data that can be useful for commanding/regulating the electronic device 1 and/or can be of interest for the user.

In one embodiment the one or more determined commands include a command of deleting one or more of said one or more displayed items X1 . . . Xn.

Accordingly, upon recognition of the blow B, one or more of the displayed items X1 . . . Xn are made disappear from the display 70.

Preferably, each item X1 . . . Xn is associated to a respective value representative of a ranking of said items. In particular, the electronic device 1 can be provided with an auxiliary memory (not shown) in which an identifier representative of each item is associated with a respective value representative of said ranking.

In this embodiment, the items to be deleted are selected based on said ranking. In particular, the ranking is an importance/priority ranking, and the items to be deleted are those having lower importance/priority according to said ranking Thus only the most important item/items remains/remain on the display 70 after the deletion command has been executed. In more detail, when the blow B is recognized, the items having lower rank in the auxiliary memory are identified and deleted from the display 70. In one embodiment, only one item can remain on the display 70 (i.e., all the items but the most important are deleted), whereas in different embodiments a higher number of items can remain on the display. Preferably the number of items that remain on the display can be set by the user.

As far as the use of the electronic device 1 is concerned, the following should be noted.

When a user wishes to activate one or more determined commands by a blow, he/she preferably activates the input interface 10 by means of the activation element 50. In particular the user presses a button included in the activation element 50, so that the input interface 10 (which includes, for example, a microphone) is active as long as the button is pressed. In a different embodiment, the input interface 10, upon operation of the activation element 50, remains active for a determined period of time (for example, a few seconds) and, after said time period, automatically returns in the deactivation condition.

When the input interface 10 is active, the user blows into the same input interface 10. FIG. 1 schematically shows a user holding the electronic device 1 and blowing into the input interface.

The blow B is converted into an electric signal ES by the input interface 10. The recognizing unit 20 recognizes the blow B based on the electric signal ES provided by the input interface 10. In particular the comparison 22 compares said electric signal ES with recognition reference data previously stored in the recognition memory 21.

Once the blow B has been recognized, i.e., when the recognizing unit 20 determines that a user has blown into the input interface 10, the execution unit 30 selects from the command memory 40 one or more determined commands and causes the execution of such commands.

As mentioned above, the commands that can be executed by the execution unit 30 can include, for example, sending a message M, preferably by means of the communication module 60, deleting one or more items from the display 70, preferably based on a ranking of said items, etc.

It has to be noted that the various elements comprised in the electronic device 1, such as for example the recognizing unit 20 and the execution unit 30, can be realized as a single hardware/software component, or as separate hardware and/or software components, capable of performing the functions herein disclosed and claimed. The command memory 40, the recognition memory 21 and the auxiliary memory can be realized as different areas of a single physical memory or as separate physical memories.

The invention achieves important advantages.

The invention provides a simple way to cause the execution of commands in an electronic device, in particular a smart phone.

In more detail the invention allows a user to easily cause execution of commands in an electronic device, in particular a smart phone, for example while holding the device in one hand with no need to use the other hand.

Furthermore, an immediate association between the way in which the command is input (blow) and the same command (e.g., sending a message, deleting items, etc.) can be established, thereby helping the user to easily remember which command is associated with this input technique.

What is claimed is:

1. An electronic device comprising:
an input interface configured for detecting sounds and translating said sounds into electric signals;
a recognizing unit configured for recognizing a blow from an electric signal provided by said input interface; and
an execution unit configured for executing one or more determined commands of said electronic device depending on the recognition of said blow.

2. The electronic device according to claim 1, further comprising a command memory storing one or more commands of said electronic device, said execution unit being configured for selecting said one or more determined commands among said one or more commands stored in said command memory.

3. The electronic device according to claim 1, wherein said recognizing unit comprises:
a recognition memory storing recognition reference data; and
a comparison unit configured for comparing the electric signal provided by said input interface with said recognition reference data.

4. The electronic device according to claim 1, wherein said input interface includes a microphone.

5. The electronic device according to claim 1, further comprising an activation element active at least on said input interface in order to selectively activate/deactivate said input interface.

6. The electronic device according to claim 5, wherein said activation element can be operated by a user.

7. The electronic device according to claim 6, wherein said activation element includes a button which activates said input interface when a user presses said button.

8. The electronic device according to claim 1, wherein said input interface is normally off.

9. The electronic device according to claim 1, further comprising a communication module configured at least for sending information to a different device, wherein said one or more determined commands include a command of sending a message through said communication module.

10. The electronic device according to claim 1, further comprising a display configured for displaying one or more items (X1 . . . Xn), wherein said one or more determined commands include a command of deleting one or more of said one or more displayed items (X1 . . . Xn).

11. The electronic device according to claim 1, further comprising a display configured for displaying a plurality of items (X1 . . . Xn), each associated to a respective value representative of a ranking of said items, wherein said one or more determined commands include a command of deleting one or more of said displayed items (X1 . . . Xn) depending on the respective value associated to each of said displayed items.

12. The electronic device according to claim 11, wherein said ranking is an importance/priority ranking, wherein said command of deleting or more of said displayed items (X1 . . . Xn) depending on the respective value of each of said items causes deletion of items having lower importance/priority according to said ranking.

13. A method comprising:
detecting a blow and translating said blow into an electric signal by means of an input interface of an electronic device;
recognizing said blow from said electric signal; and
executing one or more determined commands in said electronic device depending on the recognition of said blow.

14. The method according to claim 13, further comprising selecting said one or more determined commands among one or more commands stored in a command memory of said electronic device.

15. The method according to claim 13, wherein recognizing said blow comprises comparing the electric signal provided by said input interface with pre-stored recognition reference data.

16. The method according to claim 13, further comprising receiving at said electronic device an activation/deactivation command capable of selectively activating/deactivating said input interface.

17. The method according to claim 13, wherein said one or more determined commands include at least one or more of the following:
a command of sending a message through a communication module of said electronic device;
a command of deleting one or more items (X1 . . . Xn) displayed on a display of said electronic device.

18. The method according to claim 13, wherein said one or more determined commands include a command of deleting one or more of one or more items (X1 . . . Xn) displayed on a display of said electronic device, each of the one or more displayed items (X1 . . . Xn) being associated to a respective value representative of a ranking of said displayed items, said one or more items to be deleted being selected based on the respective value associated thereto.

19. The method according to claim 18, wherein said ranking is an importance/priority ranking, wherein said command of deleting one or more of said displayed items (X1 . . . Xn) depending on the respective value of each of said items causes deletion of items having lower importance/priority according to said ranking.

20. A non-transitory computer readable storage medium storing one or more programs comprising instructions, which when executed by an electronic device cause the device to:
detect a blow and translate said blow into an electric signal by means of an input interface of the electronic device;
recognize said blow from said electric signal; and
execute one or more determined commands depending on the recognition of said blow.
